(19) United States
(12) Patent Application Publication
(10) Pub. No.: US 2009/0007480 A1
(43) Pub. Date: Jan. 8, 2009

(54) Fishing Lure

(76) Inventor: George Robert Braun, Victoria (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/598,707

(22) PCT Filed: Mar. 9, 2005
(86) PCT No.: PCT/AU2005/000334

§ 371 Date: Sep. 18, 2008

(30) Foreign Application Priority Data
Mar. 9, 2004 (AU) 2004901230

(51) Int. Cl. A01K 85/01

(52) U.S. Cl. 43/17.1; 43/17.6

(57) ABSTRACT

A fishing lure including an illumination means; a body having walls defining a water tight cavity; a power source and a control circuit within the cavity connected to the illumination means. The control circuit controlling the supply of power to the illumination means such that light is emitted from the illumination means. The fishing lure is controllable via a remote control which can be used to select various operating modes such that the lure can produce any desired color, or pattern of colors, to emulate the body of a bait fish.

### FIELD OF THE INVENTION

The present invention relates generally to fishing equipment and, in particular, relates to a fishing lure and a system for operating and controlling same.

### BACKGROUND OF THE INVENTION

It is generally accepted that larger fish seek out smaller distressed fish as a wounded fish is an easier catch. The intended prey may either swim slowly, erratically or may twitch. The larger fish, sensing the vibrations caused by those motions, seek out these distressed fish. Tuna and marlin are known to have fluid filled sensory canals with tiny hair like receptors that are sensitive to vibrations enabling these predators to detect small vibrations in their environment.

Current fishing lures on the market attempt to replicate the motion of a distressed prey usually by shaping the body of the lure to mimic a distressed fish as it travels through the water. In addition, current fishing lures use bright paint, reflective markings or decals in an attempt to replicate the visual appearance of the intended prey.

However, there are various problems associated with trying to replicate the visual appearance of the intended prey. In order to accurately replicate a wide variety of intended prey in a multitude of environments an angler must have at their disposal a large range of different coloured lures to select from. This requirement increases the expense and equipment needed for fishing.

Electronic fishing lures are known in a general sense but none of the known electronic fishing lures allow sustained and consistent vibrations that can be timed or controlled to suit the environment or intended catch. In addition, none of the known electronic fishing lures can accurately replicate the motion of a fish through water.

Therefore, there remains a need for a fishing lure which can accurately simulate the appearance and/or motion of a fish, particularly when distressed, and which improves on the effectiveness and usability of known fishing lures.

Any discussion of documents, devices, acts or knowledge in this specification is included to explain the context of the invention. It should not be taken as an admission that any of the material formed part of the prior art base of the common general knowledge in the relevant art on or before the priority date of the claims herein.

### SUMMARY OF THE INVENTION

In accordance with a first aspect of the present invention there is provided a fishing lure including:

an illumination means;

a body having walls defining a water tight cavity;

a power source within the cavity; and

a control circuit, within the cavity, connected to the power source and the illumination means wherein said control circuit controls the supply of power to the illumination means such that, in use, light is emitted from the illumination means.

In a preferred embodiment of the invention, the illumination means is located within the cavity and the emitted light is visible through the walls of the body. In an alternative arrangement, the illumination means is located externally of the cavity on an exterior surface of the body. The walls of the body are ideally translucent or transparent and the light emitted by the illumination means can include a plurality of different colours. The illumination means preferably includes a plurality of different coloured light emitting diodes (LEDs), however a plurality of neon or incandescent light sources with coloured filters can alternatively be used.

In a preferred embodiment, the intensity of light emitted by each LED is individually controlled with the LEDs consisting of a plurality of red, green and blue LEDs. The plurality of LEDs are arranged into groups with each group including at least one red, green and blue LED located in close proximity to each other. By grouping the LEDs together in this manner, in use, light emitted by the adjacent LEDs can combine to produce light of a non primary colour. The non primary colour produced can be altered by changing the intensity of light emitted by one or more of the LEDs in each group via the control circuit. The groups of LEDs can be spaced uniformly with respect to the fishing lure such that the entire surface of the body can be illuminated. The ability of the fishing lure to emit a multitude of different colours provides the angler with a highly versatile lure that eliminates the need for the angler to have at their disposal a large number of different coloured lures.

In another embodiment, the illumination means includes a light source operably connected to a flexible fibre that is placed within the cavity. The fibre is preferably of a sufficient length to be located throughout the cavity and act to carry and transmit light from the source. Of course, different fibres may be used for different coloured light sources and by placing the different fibres in close proximity throughout the cavity it is possible to illuminate the cavity with non-primary colours. In an alternative embodiment the fibres may be wound around the exterior of the cavity.

In yet another embodiment the body having walls defining a water tight cavity includes a first portion and a second portion in connection therewith. Within the cavity of the first portion, at least one actuator may be provided. The actuator being in operable connection with the second portion such that in use, the actuator imparts movement to the second portion. In this regard, the control may be connected to the at least one actuator to thereby control operation of the actuator.

Preferably, the control circuit controls the actuator according to a desired pattern of movement of the second portion. The first portion may be shaped substantially similar to the head and/or body of a fish and the second portion is preferably shaped similar to a tail with the pattern of movement preferably mimicking that of a fish in distress.

In another embodiment the fishing lure further includes vibration means, within the cavity, adapted to impart a vibration to the body of the fishing lure. The control circuit may be arranged to apply power from the power source to the vibration means according to a desired operation pattern.

In a further embodiment the control circuit is adapted to intermittently apply power to both the vibration means and actuator according to a desired duty cycle and/or frequency. Preferably the duty cycle and/or frequency applied to the vibration means and actuator are different.

In a preferred embodiment, the vibration means includes a motor having a rotatable output shaft and a weight eccentrically mounted on the shaft. The motor and weight may be of the type used in mobile phones having a vibration mode.

In yet another embodiment, the control circuit includes a receiver such that upon the receiver receiving control signals, the control circuit can control operational functions of the lure in accordance with pre programmed instructions stored in the control circuit

Preferably, control signals are transmitted to the receiver by a remote control unit located remotely from the fishing lure. By being able to control the illumination and/or intensity and/or duration of any vibrations or movement of a lure via the remote control unit, the angler can advantageously select and change the pattern of movement and colour of the lure. Preferably, control signals are communicated to the lure prior to casting or after the lure has been cast such that it is not necessary to retrieve the lure from the water.

In an alternative embodiment, the control circuit may also include a water sensing circuit having electrodes exposed externally of the walls of the body. In this embodiment the sensing circuit may be adapted to activate the vibration means and/or the actuator and/or the illumination means when the electrical resistance between the electrodes drops below a threshold. This may occur when the fishing lure is placed in water with the threshold preferably being adjustable.

In yet another embodiment, there is provided a fishing lure system which includes the fishing lure and a charger. The fishing lure may have a rechargeable electrical power source, within the cavity, and a first inductor operatively connected to the at least one rechargeable power source whilst the charger, located remotely from the fishing lure, includes a second inductor. The charger is operatively connected to an external power source and by locating the fishing lure in proximity to the charger, the rechargeable electrical power source of the fishing lure is replenished.

Preferably, the second inductor includes an opening such that a portion of the body of the lure may be located within the opening during recharging of the electrical power source. Alternatively, the second inductor may include a planar support surface with a portion of the body being located on the planar support surface during recharging of the electrical power source.

In accordance with a further aspect of the present invention there is provided a fishing lure system: including a fishing lure having a programmable control circuit and a power source connected thereto, said programmable control circuit controlling operational functions of the fishing lure; and programming means for programming the programmable control circuit.

### BRIEF DESCRIPTION OF THE DRAWINGS

Further benefits and advantages of the invention will become apparent from the following description of a preferred embodiment of the invention. The preferred embodiment should not be considered as limiting any of the statements in the previous section. The preferred embodiment will be described with reference to the following Figures in which:

FIG. 1 is a side view of the exterior of a fishing lure in accordance with a preferred embodiment of the invention;

FIG. 2 is a side view of a fishing lure similar to that of FIG. 1 showing the internal components;

FIG. 3 is a side view of the exterior of a fishing lure similar to that of FIG. 1 showing the sensing circuit electrodes of the fishing lure in accordance with a further embodiment of the invention;

FIG. 4 is an electrical schematic diagram of a fishing lure in accordance with a preferred embodiment of the invention;

FIGS. 5 to 8 are electrical schematic diagrams of alternative embodiments of the invention;

FIG. 9A is a perspective view of a rechargeable fishing lure and a charger;

FIG. 9B is a perspective view of a rechargeable fishing lure partially located within the cavity of a charger;

FIG. 10 is a side view partially illustrating the internal components of a fishing lure according to an embodiment of the invention.

### DESCRIPTION OF THE PREFERRED EMBODIMENTS

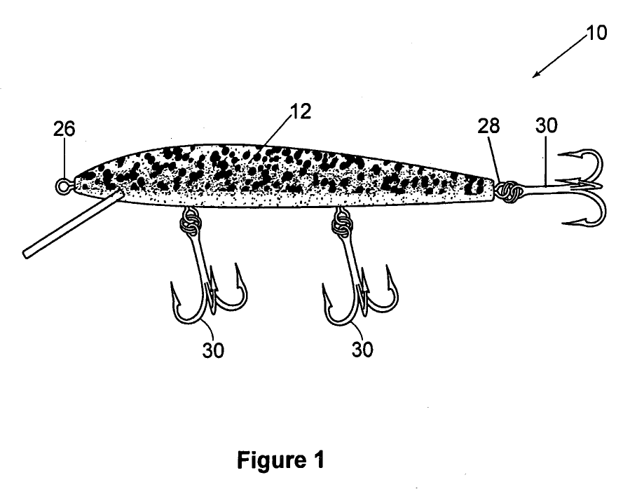

Referring to FIG. 1, there is shown a fishing lure in accordance with an embodiment of the invention. Externally, this fishing lure looks identical to a conventional fishing lure. Indeed, the components of the present invention may be incorporated within the body of a conventional fishing lure.

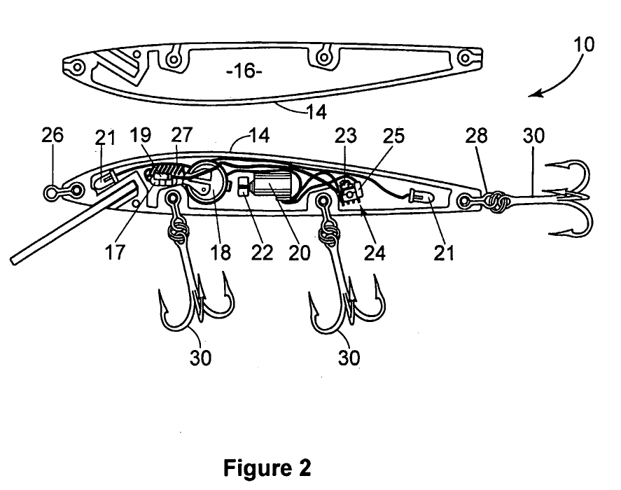

FIG. 2 shows the internal components of a fishing lure similar to that shown in FIG. 1. It can be seen from FIGS. 1 and 2 that the fishing lure 10 includes a body 12 having walls 14 which define a water tight cavity 16. The lure 10 includes a power source in the form of a rechargeable battery 18 within the cavity 16. An illumination means is provided in the form of light emitting diodes 21 that are located at a multiple number of locations within the body of the lure.

A control circuit 24 is arranged to apply power from the battery 18 to the light emitting diodes 21. The control circuit 24 includes a microprocessor 23 which controls the intensity and duration of light emitted by each LED such that the desired light colour is emitted. A speaker can also be connected to the battery 18 and the control circuit 24 to emit sound as close as possible to a fish in distress.

Further, the control circuit 24 includes an infrared receiver 25 which receives control signals from a transmitter of a remote control unit. The remote control unit is located remotely from the body and transmits transmission signals to the receiver to control all operational functions of the lure including the switching on of the lure. In this regard, the transmission signals are preferably either infrared or of radio frequency. Whilst the lure is preferably switched on via remote control a manually operated switch can also be provided on the lure. Further, a reed switch can be located in lure which cuts power to the lure when the lure is exposed to a magnetic field. In this regard, a magnet can be provided in the packaging of the lure such that when the lure is returned to the packaging for storage following use the reed switch will cut power to the lure.

The remote control can be used to select various operating modes and parameters such that the body of the fishing lure mimics the actions, appearance, sound and movement as close as possible to the real actions of all types of fish when distressed. Operational modes and parameters control all facets of the lure including which group of LEDs are activated, illumination duration and intensity, vibration duration and intensity and operation of the actuator.

The vibration means is provided in the form of an electric motor 20 and an eccentrically mounted weight 22 on the output shaft of the motor 20. The control circuit 24 is arranged to apply power from the battery 18 to the motor 20 according to a desired pattern such as a desired duty cycle and/or desired frequency. To ensure that the vibration means does not draw excessive current from the battery 18, power signals supplied to the motor 20 can be pulse width modulated.

In one embodiment, the control circuit 24 also includes a water sensing circuit having a pair of electrodes 26 and 28 exposed externally of the walls of the body 12. The sensing circuit is adapted to activate the motor 20 when the electrical resistance between the electrodes 26 and 28 drops below a threshold.

In the embodiment shown in FIG. 2, the electrode 26 also functions as a means to attach the body of the lure to a fishing line. The electrode 28 shown in FIG. 1 also serves to attach one of several fishing hooks 30.

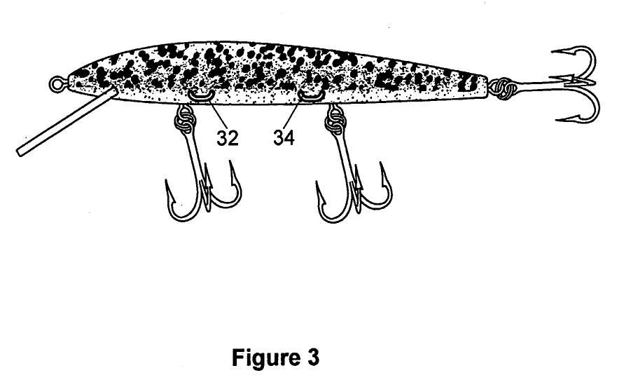

The embodiment shown in FIG. 3 is similar to those shown in FIGS. 1 and 2 but the sensing circuit includes electrodes 32 and 34 which are dedicated to this purpose and do not serve a dual role as in the embodiments shown in FIGS. 1 and 2.

In use, the water sensing circuit activates when the resistance between the two electrodes 26 and 28, or 30 and 34, drops below a threshold. This will then activate a timing circuit which, in a preferred embodiment, has a cycle time of 4 seconds (2 seconds off and 2 seconds on). This timing may however be varied as desired, for example from 0-60 seconds for both the on and off times. Alternatively, random timings or user programmable timings may be employed. In a particularly preferred embodiment, the control circuit 24 includes a microprocessor or similar device.

A driver circuit is used to switch on the motor 20 of the vibration means. As the motor 20 rotates the weight that is off-centred also rotates thereby creating vibrations of the motor body. The motor body is rigidly mounted to the body of the lure so as to transfer the vibrations to the body of the lure, and hence through to the water.

When the lure is dry the control circuit 24 draws an insignificant current from the battery 18, thereby preserving battery life. Further, the circuitry connected to the water sensing electrodes is protected against damage due to short circuit.

Getting the electronic and mechanical components of the device in to such a small area has in the past precluded this concept from being implemented. By using surface mount electronic components, low stand-by current design and components from the mobile phone industry, miniaturisation is possible.

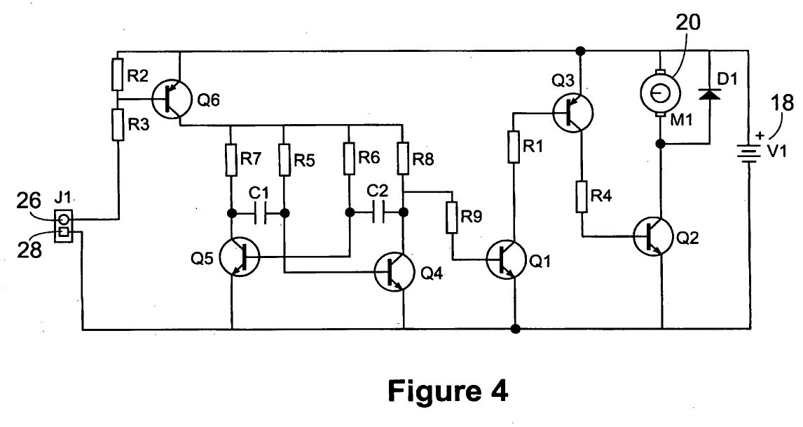

Referring now to FIG. 4, there is shown an electronic circuit diagram of an embodiment of the present invention.

When the fishing lure is placed in the water a small current will flow via R2 and R3 through water between the two electrodes J1 that penetrate the body of the lure. This current will be sufficient to forward bias transistor Q6 and saturate it. Once Q6 has saturated, Q4 and Q5 have sufficient power to function as an a stable multivibrator oscillating at around 0.5 Hz based on the values of R5 and C1 for one phase and R6 and C2 for the other. Resistor values are set high to keep the capacitor values small and also reduce current drain of the circuit. Every two seconds, Q4 will switch off providing enough current through R9 to saturate transistor Q1. It has been found that only 0.2 microamp of current can be drawn from the oscillator without adversely affecting the timing of the oscillator. Also, this is not enough current to start the vibrating motor. The collector base design of the three stages of amplification is used since it has no quiescent current and a massive current gain in excess of 1 million. Two further stages of amplification to boost the 0.1 microamp of bias up to the 100 milliamp required to start the vibration motor. Any current passed into this circuit via R9 will then be amplified up to over 100 milliamps sink capability at the collector of transistor Q2. Although the back emf of the mechanical vibrator is small, diode D1 is used to arrest any problem.

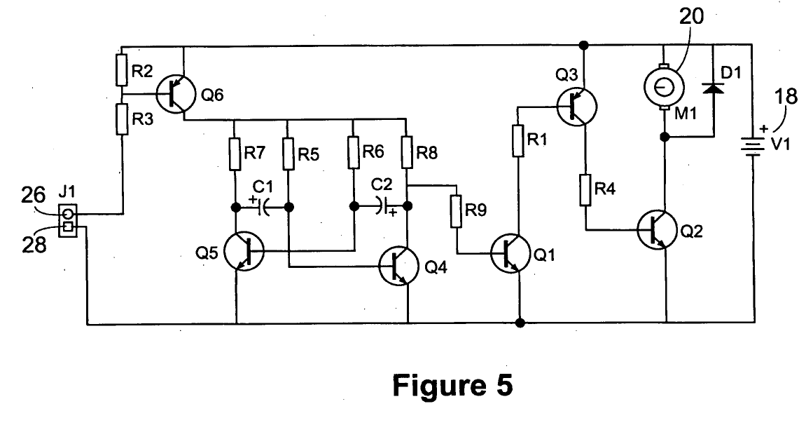

FIG. 5 shows a circuit diagram similar to that of FIG. 4 wherein merely the values of the resistors and capacitors have been varied so as to change the duty cycle and frequency compared to the circuit shown in FIG. 4.

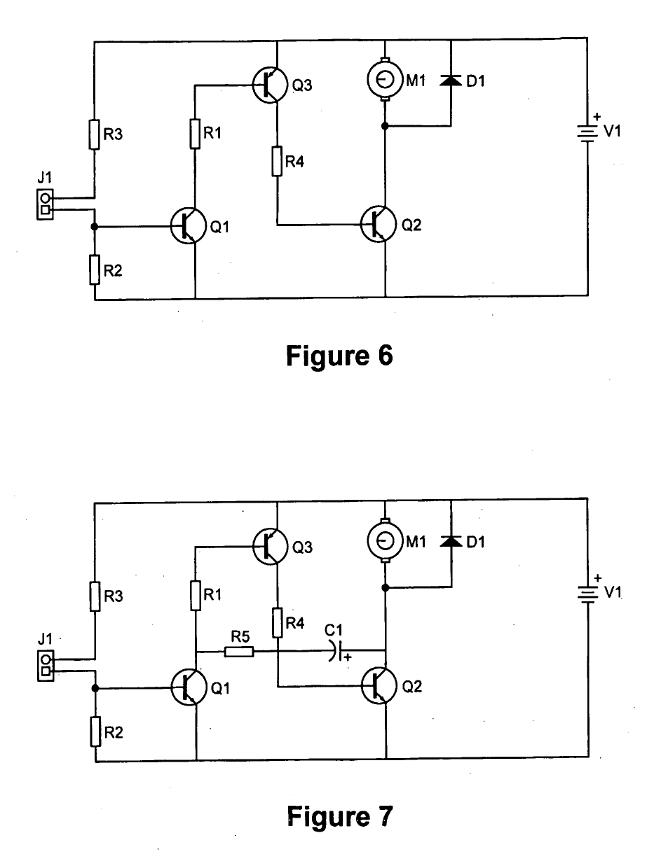

FIGS. 6, 7 and 8 show electrical circuit schematic diagrams of alternative embodiments of the invention.

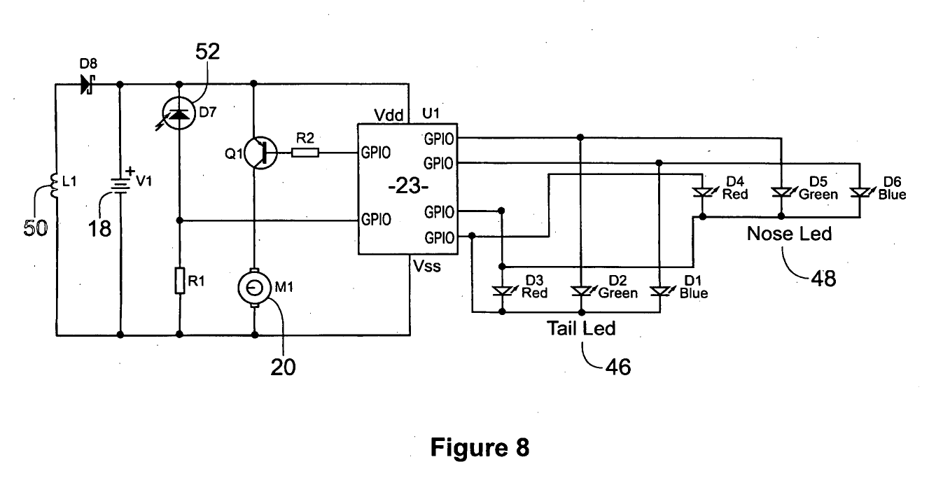

The circuit diagram in FIG. 8 depicts two groups of LEDs 46 and 48 connected to a microcontroller 23. The microcontroller 23 accepts commands from the remote control via an infrared receiver diode 52. The microcontroller 23 can operate at 4 MHz using an on-chip RC oscillator. The range of the remote control can be maximised by using a hybrid receiver unit.

Each group of LEDs includes a red green and blue LED with a first group being located in the nose portion of the lure with a second group located in the tail portion. A first inductor 50 is provided in parallel with the battery 18 to facilitate in the recharging of the battery 18.

In a variable timing model of the fishing lure, the on and off times may be adjusted to suit the species of fish to be caught. In random timing models, the lure may use a random number generator in a small micro-controller to create the timing sequence. A multiple number of different timing sequences can be implemented simultaneously. For example, the timing sequence for the vibration of the lure and the actuation of the tail section can be selected to suit a particular species of fish.

A PC based laptop computer with a parallel port may be used to load a user defined timing sequence into the lure. Alternatively, an infra-red or radio communication port may be employed. Tables may be provided to find the optimum match between the fish species or geographic location and appropriate timings. The user may also be provided the ability to program their own illumination requirements and timing sequence for vibration and/or actuation of the tail section. In addition, the user may select a standard vibration pattern program having regular vibrations or random vibrations to mimic a distressed fish. Similarly, a standard illumination pattern program can also be selected by the user. In this regard, a standard illumination pattern program for squid jigs is provided which provides a sequenced illumination along the body of the jig to provide the illusion of the squid jig darting through the water.

A PC based laptop computer may also be used to record the sound of a fish in distress. The signal recorded can then be programmed into a fishing lure such that the lure can then vibrate and/or emit sound in accordance with the signal recorded.

Various illumination, vibration and actuation pattern programs can be accessed and selected by the angler via the remote control. Vol+ and Vol− buttons are provided on the remote control together with Ch+, Ch− and On/Off buttons. The buttons select and control various features depending upon the program selected. For example, the Ch+ and Ch− buttons in some instances may be used to increase and decrease the speed at which the illumination flashes, whilst the Vol+ and Vol− buttons may be utilised to activate and deactivate sequenced illumination along the body of the lure. In addition the remote control permits the activation of different effects within the lure. For example, an effect in the tail section of the lure can be controlled and activated in isolation to an effect in the nose section of the lure.

The following is an example of one of the programs which can be accessed by the angler. This particular program relates to illumination of the lure and has been produced in C programming language.

***************************************************************************/

| | |
|---|---|
| /* Program | : #47VarGB.C */ |
| /* Function | : Demo board for IR controlled learning lure */ |
| /* Author | : Mark Gibbs */ |
| /* Language | : HiTech C (ANSI C) */ |
| /* Platform | : Microchip PIC |
| */ | |
| /* Target | : 12f675 in Squid lure */ |
| /* Development | : 12F675 @ 4 Mhz */ |
| /* Target Hardware | : 12F675 on small demo board */ |
| /* | : 12F675 must be calibrated for this code to |
| work. */ | |

/* : Use full optimisation during compilation. */

| | |
|---|---|
| /* Version | : 02 */ |

```
/* Revisions  */
/* Rev No. Rev date  Description  */
/* ------- --------  ----------------------  */
/* */
/* 1  */
/* 0 23/May/04 Converted to PWm RGB led  */
/*
*/
/***************************************************************************/
#include <pic.h>
//#include <stdlib.h>
_CONFIG(INTIO & WDTDIS & MCLRDIS & BOREN & PROTECT & PWRTEN);
// function prototypes
void init(void);
// Action Variables
unsigned char Activity, ActivityTimer;
unsigned char databit, test, c, code, button;
bit TempStartUp, IRcodeready, NewKey, Learn, power, motor, PwmSync, b
,NewActivity, NewLed;
bit keylockout, validkey, NewVib, VibOn;
unsigned int keytimer,count, thousands;
unsigned char Mark;
unsigned char Space;
unsigned char colour, blue, green, red, pwm, newcol;
/***************************************************************************/
/* Main Program  */
/***************************************************************************/
main( ) {
for(test = 0; test<250; test++); // waste more time during power up
init( ); // set up all port direction registers.
count = 0;
databit = 7;
test = 0;
IRcodeready = 0;
NewKey = 0;
Learn = 0;
validkey = 0;
keylockout = 0;
power = 1;
TempStartUp = 0;
NewLed = 1;
Mark = 5;
Space = 5;
NewVib = 1;
red = 50;
green = 50;
blue = 0;
colour = 1;
newcol = 20;
while(1) { // This is the main program endless loop.
    if(power){
        if(IRcodeready && !keylockout ){// New button press available!
            if(button == 16){ // CHup button
                if(colour < 2) colour += 1;
// green += 25;
                newcol = 15;
                validkey = 1;
            }
            if(button == 17){ // CHdn button
                if(colour > 0) colour −= 1;
                newcol = 15;
                validkey = 1;
            }
            if(button == 18){ // VOLup button
                if(colour == 0) if(red < 250) red += 50;
                if(colour == 1) if(green < 250) green += 50;
                if(colour == 2) if(blue < 250) blue += 50;
                validkey = 1;
            }
            if(button == 19){ //VOLdn button
                if(colour == 0) if(red > 0) red −= 50;
                if(colour == 1) if(green > 0) green −= 50;
                if(colour == 2) if(blue > 0) blue −= 50;
                validkey = 1;
            }
            if(validkey){
                keylockout = 1;
                IRcodeready = 0;
                validkey = 0;
            }
        } // end if IRcode
        if(newcol){
            GPIO0 = 0; // Red
            GPIO1 = 0; // Blue
            GPIO2 = 0; // green
            if(colour == 0) GPIO0 = 1;
            if(colour == 1) GPIO2 = 1;
            if(colour == 2) GPIO1 = 1;
        } else{
            pwm += 5
            if(pwm < red) GPIO0 = 1;
                  else GPIO0 = 0;
            if(pwm < green) GPIO2 = 1;
                else GPIO2 = 0;
            if(pwm < blue) GPIO1 = 1;
                else GPIO1 = 0;
        }
    }// end if power)
// Button has been relased!
    if(!keytimer){
        if(TempStartUp) power = 0;
        keylockout = 0; // OK to gather a new key
        IRcodeready = 0; //not sure why we need this here but we get
another key code at the end of keytimeout if it is removed
        validkey = 0;
        databit= 7;
// if(power == 0){
// // time to go to sleep;
// GPIO = 0; //shut off all power draining devices.
// GIE = 0;
// asm(“sleep”);
// asm(“nop”);
// for(test = 0; test<250; test++);
// GPIF = 0;
// GIE = 1;
// TempStartUp = 1; // get ready for wake up and start scanning
IR
// }
    } // end if !keytimer
    if(IRcodeready && !keylockout){
        if(button == 0){ // Power on button pushed
// power = 1;
// TempStartUp = 0;
// NewLed = 1; // refresh LEDs after shutting down the GPIO
            validkey = 1;
        }
        if(button == 21){ // Power off button pushed
// power = 0;
// GPIO = 0; // make it look like we have already gone to sleep.
            validkey = 1;
        }
        if(validkey){
            keylockout = 1;
            IRcodeready = 0; // found a valid code no need to come back
in here
            validkey = 0;
        }
    }// end if IRcode ready && !keylockout
} // end of while endless loop
}// end of main
static void interrupt isr(void)
{
  // work out source of interrupt
    if(T0IF){  // Was this a timer ZERO overflow? Here every 100us.
        TMR0 = −86;  // set for 40 Khz  −15 = 25us, −40 = 50us, −90 =
100us
      count++;  // Add 1 to count - insert idle comment
        if(keytimer) keytimer−−; // decrement keytimer.
        if(thousands−− == 0){
            thousands = 1000; // here once every 100 milliseconds;
            if(newcol){
                newcol−−;
            }
        }
      T0IF = 0;  // Clear interrupt flag, ready for next
}
if(GPIF) { // Here whenever a port change interrupt occurs.
        if(GPIO3) {//check for correct edge due to interrupt on change.
            if(databit) { //
                if((count >= 10) && (count <15)){// probably a zero ,,
was >=10 to <15
            code &= 0x7f;
                    code >>= 1;
            databit−−;
                }
                if((count >16) && (count <20)){ // probably a one,, was
16 to 20
                    code |= 0x80;
                    code >>= 1;
                    databit−−;
        }
            } // end if databit < 8
            if((count >22) && (count <40) && (!keylockout)){ // start pulse
        databit = 7;
                code = 0x02;
      }
            if(databit == 0){
                IRcodeready = 1; // got all the bits we need, let the
main routine know
                button = code;
            }
            count = 0;
        } // end of if(GPIO3)
        keytimer = 1420; // if no edges for 30ms we can assume the button
has been relased.
    GPIF = 0;
    }// end if GPIF
}// end or ISR
void init(void){
    #asm
```

| | |
|---|---|
| call 0x3FF | //Load Factory Calibration Value Into |
| OSCCAL | |
| bsf _STATUS,5 | //Select BANK1 |
| movwf _OSCCAL | |
| #endasm | |
| //12f675 setup | |
| ANSEL = 0; | //PIC12F675 Only |

| | |
|---|---|
| TRISIO = 0b00001000; | //GP0-Output, GP1-Output,GP2-Output,GP3- |

Input,GP4-Output,GP5-Output

| | |
|---|---|
| VRCON = 0; | //Turn Off Vref |
| CMCON = 0x07; | //Turn Off Comparator |

| | |
|---|---|
| OPTION = 0b11001000; | //Pull Ups Disabled, Rising Edge, Prescaler 1:1 |
| WDT | |
| // 76543210 | |
| T1CON = 0b00000101; | // Timer 1 enabled with int oscillator. |
| TMR1H = 0xff; | |
| TMR1L = −10; | |

| | |
|---|---|
| // TMR1GE = 0; | //Timer1 always onEnabled (A Low |
| Increments Timer1) | |
| // TMR1ON = SET; | //Timer1 On Enabled |
| // 76543210 | |
| INTCON = 0b11101000; | // GIE-enabled, TMR0 int enabled, |

GP2/int disabled, Port change int enabled.
// 76543210

| | |
|---|---|
| IOCB = 0b00001000; | // Select Interrupt on change pins. Gp3 |
| int | |

| | |
|---|---|
| PIE1 = 0x00; | // Disables peripheral interrupts. |
| } | |

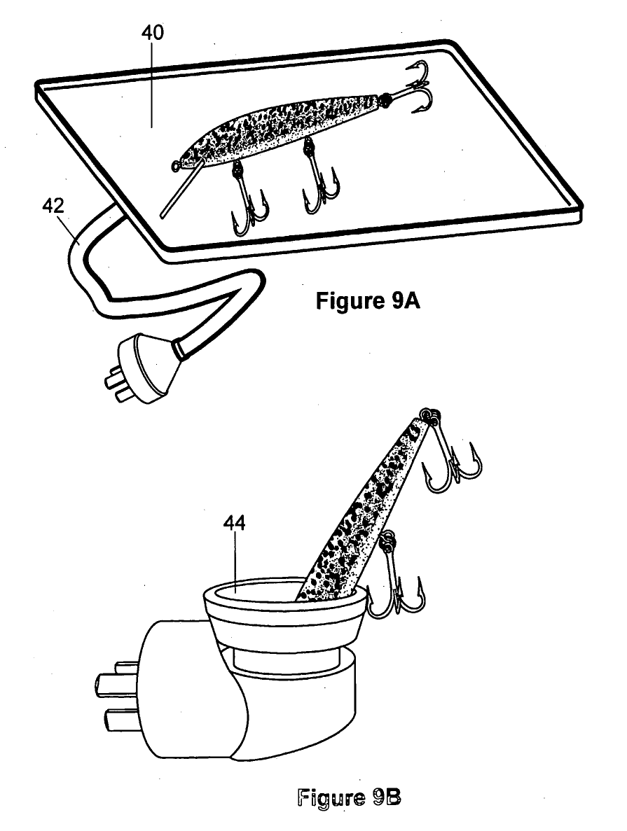

With reference to FIG. 9A there is depicted a charger for recharging the fishing lure. The body of the fishing lure contains the first inductor 50 and the charger includes a second inductor contained in a planar support surface 40. The charger further includes a power cord 42 for connection to an external power source. The rechargeable batteries within the body of the fishing lure are recharged by placing the body of the fishing lure on the planar support surface 40.

An alternative embodiment of the charger is depicted in FIG. 9B. In this embodiment, the rechargeable batteries with the body of the fishing lure are recharged by placing a portion of the body within a cavity 44 containing a circular inductor.

In a further embodiment, the rechargeable batteries may use the electrodes to recharge the internal battery. The battery charger can either be plugged into a 12 volt DC car dash socket or may be mains or solar powered.

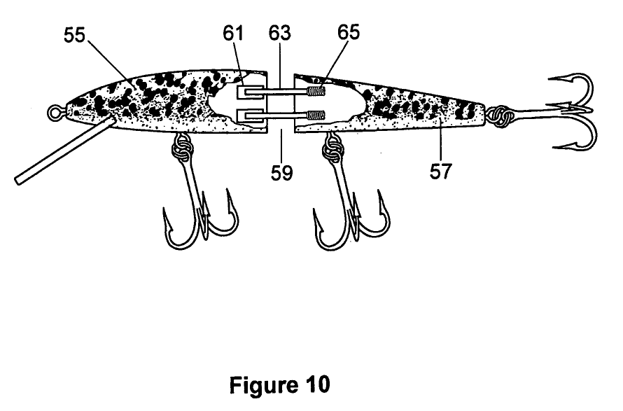

With reference to FIG. 12 there is depicted the body of a fishing lure which includes a first or nose portion 55 and a second or tail portion 57. The nose portion 55 is connected to the tail portion 57 by two actuators 59. Each actuator 59 includes a solenoid 61 mounted in the nose portion 55. From each solenoid 61 extends an arm member 63 which has one end connected to the tail portion 57 via a return spring 65. Other components have been removed from FIG. 10 for clarity. In use, each solenoid 61 receives an electrical impulse in accordance with a preselected timing sequence selected by the user to replicate the desired movement of the tail portion. The magnetic field created within each solenoid forces each arm member 63 towards the tail portion 57 against the bias of the spring 65. When the electrical impulse ceases, each arm member 63, returns to its prior position. By providing the electrical impulses in an alternative sequence to each solenoid, back and forth motion is provided to the tail portion.

Premium models of the fishing lure may incorporate several of the features described including illumination, vibration, remote control, recharging, sound and tail actuation.

Basic models may be designed to be disposable whereas premium models may be designed to have an extended life span of up to 1000 charge/discharge cycles.

The control circuit may be configured to operate the vibration or activation modes according to any desired duty cycle and/or frequency. Examples are given in the following table:

| On Period (seconds) | Off Period (seconds) |
|---|---|
| 1 | 1 |
| 2 | 2 |
| 3 | 3 |
| 3 | 1 |
| 4 | 2 |

Any other suitable combination may be employed depending upon the type of fish that the lure is intended to emulate.

Sensitivity of the water sensing circuit needs to be considered with variations of pH levels of water throughout the world. Preferably, the water sensing circuit is adapted to work within a pH range of 5.0 to 9.0. However, operation outside of this range may be desirable.

Similarly, fresh water will be less conductive than salt water and clean water will be less conductive than dirty water. The water sensing circuit employed in the fishing lure of the present invention may be adapted, as necessary, to work in any water conditions. Such adaptation would be considered to fall within the skill of an ordinary person within the art and need not be explained here in detail.

### CONCLUSION

A fishing lure constructed in accordance with a preferred embodiment of the invention may incorporate the following features and advantages:

Eliminates the need for the angler to have a large number of different coloured lures;

Pre-stored programs enable the angler to choose the most appropriate colour to illuminate the lure depending upon the intended catch;

The ability for the angler to program their own illumination requirements, in addition to timing sequences for vibration and actuation of the tail section;

Ability to simulate the motion of a fish through water, particularly the erratic behaviour of a fish in distress; and

Illumination to produce any desired colour, or pattern of colours, to emulate the body of a bait fish;

As the present invention may be embodied in several forms without departing from the essential characteristics of the invention, it should be understood that the above described embodiment should not be considered to limit the present invention but rather should be construed broadly within the spirit and scope of the invention. Various modifications and equivalent arrangements are intended to be included within the spirit and scope of the invention.

1. A fishing lure including: an illumination means; a body having walls defining a water tight cavity; a power source within the cavity; and a control circuit, within the cavity, connected to the power source and the illumination means wherein said control circuit controls the supply of power to the illumination means such that, in use, light is emitted from the illumination means.

2. A fishing lure as claimed in claim 1 wherein the illumination means is located within the cavity and the emitted light is visible through the walls of the body.

3. A fishing lure as claimed in claim 1 wherein the illumination means is located externally of the cavity on an exterior surface of the body.

4. A fishing lure as claimed in claim 2 wherein the walls of the body are translucent.

5. A fishing lure as claimed in claim 2 wherein the walls of the body are transparent.

6. A fishing lure as claimed in claim 4 wherein the illumination means includes a plurality of different colored light emitting diodes (LEDs).

7. A fishing lure as claimed in claim 6 wherein in use, the intensity of light emitted by each LED is individually controlled.

8. A fishing lure as claimed in claim 6 wherein the plurality of different colored LEDs includes more than one combined red, green and blue LED.

9. A fishing lure as claimed in claim 6 wherein the plurality of LEDs are arranged in groups with each group including a red, green and blue LED located in close proximity to each other.

10. A fishing lure as claimed in claim 9 wherein in use, the light emitted by the adjacent LEDs combines to produce light of a non-primary color.

11. A fishing lure as claimed in claim 10 wherein the non-primary color produced is altered by changing the intensity of the light emitted by one or more of the LEDs.

12. A fishing lure as claimed in claim 1 further including: vibration means within the cavity for imparting a vibration to the body of the fishing lure, wherein the control circuit is arranged to apply power from the power source to the vibration means according to a desired vibration operation pattern.

13. A fishing lure as claimed in claim 12, wherein the control circuit is adapted to intermittently apply power to the vibration means according to a desired duty cycle and/or frequency.

14. A fishing lure as claimed in claim 12, wherein the control circuit includes a water sensing circuit having electrodes exposed externally to the walls of the body and wherein the sensing circuit is adapted to activate the vibration means and/or illumination means when the electrical resistance between the electrodes drops below a threshold.

15. A fishing lure as claimed in claim 12, wherein the vibration means includes a motor having a rotatable output shaft and a weight eccentrically mounted on the shaft.

16. A fishing lure as claimed in claim 1, wherein the control circuit includes a receiver such that upon the receiver receiving control signals the control circuit controls operational functions of the lure.

17. A fishing lure as claimed in claim 16 wherein operational functions of the lure include vibration and illumination of the body.

18. A fishing lure as claimed in claim 17 wherein the control of the illumination function permits illumination of the body with desired colors.

19. A fishing lure as claimed in claim 18 wherein the control of the illumination function further permits activation and de-activation of the illumination function.

20. A fishing lure as claimed in claim 18 wherein the control of the vibration function permits activation and de-activation of vibration to the body.

21. A fishing lure as claimed in claim 17 wherein the control of the vibration function permits the intensity and duration of the vibrations to be varied.

22. A fishing lure as claimed in claim 1 wherein the body having walls defining a water tight cavity includes a first portion and a second portion, the first and second portions being connected; at least one actuator, within the cavity of the first portion and in operable connection with the second portion, said actuator, in use, imparting movement to the second portion; and wherein the control circuit is connected to the at least one actuator and thereby controls operation of the actuator.

23. A fishing lure as claimed in claim 22 wherein the control circuit controls the actuator according to a desired pattern of movement.

24. A fishing lure system including: a fishing lure as claimed in claim 1, the fishing lure further including: a rechargeable electrical power source, within the cavity, and a first inductor operatively connected to the at least one rechargeable power source; and
a charger located remotely from the fishing lure, including a second inductor, the charger operatively connected to an external power source, wherein locating the fishing lure in proximity with the charger replenishes the rechargeable electrical power source.

25. A fishing lure system as claimed in claim 24 wherein the second inductor includes an opening, a portion of the body being locatable within the opening during recharging of the electrical power source.

26. A fishing lure system as claimed in claim 24 wherein the second inductor includes a planar support surface, a portion of the body being locatable on the planar support surface during recharging of the electrical power source.

27. A fishing lure system as claimed in claim 24 wherein the second inductor includes a cavity, a portion of the body being locatable within the cavity during recharging of the electrical power source.

28. A fishing lure system including: a fishing lure having a programmable control circuit and a power source connected thereto, said programmable control circuit controlling operational functions of the fishing lure; and programming means for programming the programmable control circuit.
